(19) United States
(12) Patent Application Publication
(10) Pub. No.: US 2009/0184207 A1
(43) Pub. Date: Jul. 23, 2009

(54) Synchronously self deploying boom

(76) Inventors: Peter A. Warren, Newton, MA (US); Benjamin J. Dobson, Arlington, MA (US); Mark J. Silver, Maynard, MA (US)

Correspondence Address: Iandiorio & Teska, 260 Bear Hill Road, Waltham, MA, 02451-1018, US

(21) Appl. No.: 12/009,752

(22) Filed: Jan. 22, 2008

(51) Int. Cl. B64G 1/22; B66C 23/42

(52) U.S. Cl. 244/172.6; 212/299

(57) ABSTRACT

A deployable boom with adjacent panels hinged together typically in an end to end configuration. A first longeron is attached to at least two panels and a second longeron is also attached to at least two panels. Each longeron includes a self locking hinge between adjacent panels.

### FIELD OF THE INVENTION

This subject invention relates to a foldable boom and other similar structures.

### BACKGROUND OF THE INVENTION

Optical and other instruments deployed in outer space require a precise and stable structural platform. In some prior mechanically deployed structures, components are moved from their stored position into their final operational position by some type of an actuator and then locked into place with a deployment latch. Existing deployable structure joints have several limitations that either completely prevent them from being used in high precision deployable instruments or require additional launch mass to provide deployment actuation and post deployment locking.

Recently, foldable truss members have been developed so that a truss structure can be collapsed and compactly packaged to save space during delivery and then released to expand and return to their original shape in orbit. Various deployment mechanisms add to the mass, expense and complexity of the structure and to the difficulty and expense of transporting it. Some foldable members have reduced mass by replacing the hinge, latch, and actuator mechanisms with the single device. See, e.g., U.S. Pat. No. 4,334,391 incorporated herein by this reference.

Deployable boom systems can be broadly classified in three categories, uncontrolled, sequential, and synchronous. Uncontrolled deployments are very simple, but the trajectory of the deployment is uncontrolled and thus unknown. The result can potentially lead to unsafe conditions when the boom impacts neighboring equipment during deployment.

Sequentially deployed booms deploy their structure in sections, typically one bay at a time. Since each structural section has to be commanded to be deployed, such booms typically require motors or other electronic actuators to effect deployment. The motors are expensive, heavy, and perform no useful function once the deployment is complete.

Synchronously deployed booms deploy all at once, but do so in a controlled manner so that their trajectory is known and bounded. When the synchronously deployed boom relies on a motor or spring, stiffness can be limited, the motor adds weight to the system, and the result can be an imprecise deployment.

### SUMMARY OF THE INVENTION

It is therefore an object of this invention to provide a new deployable boom.

It is a further object of this invention to provide such a deployable boom which automatically locks in place once deployed.

It is a further object of this invention to provide such a deployable boom which can be collapsed to a fairly small volume.

It is a further object of this invention to provide such a deployable boom including hinges which provide substantial bending stiffness orthogonal to the direction of deployment.

It is a further object of this invention to provide such a deployable boom which does not rely on motors or other actuators to deploy the boom.

The subject invention results from the realization that a boom collapsible to a fairly small volume and which self deploys and then automatically locks in place once deployed is effected by a system of panels hinged together so they fold up next to each other in combination with longerons attached to the panels with self locking hinges between adjacent panels.

The subject invention, however, in other embodiments, need not achieve all these objectives and the claims hereof should not be limited to structures or methods capable of achieving these objectives.

The subject invention features a deployable boom with adjacent panels hinged together typically in an end to end configuration. A first longeron is attached to at least two panels and a second longeron is also attached to at least two panels. Each longeron includes a self locking hinge between adjacent panels.

Preferably, the first longeron is pivotably connected to one edge of each panel and the second longeron is pivotably connected to an opposite edge of each panel. The preferred self locking hinge includes foldable plies of material. In one example, a first set of plies of foldable material is secured on opposite ends thereof to the spaced ends of longeron sections bridging the gap therebetween and a second set of plies of foldable material is secured on opposite ends thereof to the spaced ends of the longeron sections bridging the gap therebetween opposite the first set of plies.

In one example, a third longeron spans one side of the hinged joints between adjacent panels and a fourth longeron spans an opposite side of the hinged joints between adjacent panels. The third and fourth longerons may include self locking hinges between adjacent panels and, in addition, a hinge pivotably attached proximate a hinged joint between adjacent panels. The longerons can be made of composite material.

In one embodiment, the panels are solid. But, the panels may also be frames. In one example, the panels include cut outs for accommodating the optional third and fourth longerons when the boom is folded.

Further included may be means for regulating the rate of deployment of the panels such as a lanyard wound about a damping reel and secured to at least one panel.

In one embodiment, the deployable boom comprises adjacent panels hinged together, a first longeron attached to an edge of at least two panels including a self locking hinge between the two panels, a second longeron attached to an edge of at least two panels including a self locking hinge between the two panels, a third longeron spanning one side of the hinged joints between adjacent panels, and a fourth longeron spanning an opposite side of the hinged joint between adjacent panels.

In one example, adjacent panels are hinged together in an end to end configuration. A first longeron is pivotably attached to an edge of each panel and a second longeron is pivotably attached to an opposite edge of each panel. Each of the first and second longerons include a self locking hinge between adjacent panels. A third longeron spans one side of the hinged joints between adjacent panels and a fourth longeron spans an opposite side of the hinged joints between adjacent panels. The third and fourth longerons typically include self locking hinges between adjacent panels. Each of the third and fourth longerons may further include a hinge pivotably attached proximate a hinged joint between adjacent panels. Each self locking hinge preferably includes foldable plies of material.

One deployable boom includes adjacent panels hinged together in an end to end configuration, a first longeron pivotably attached to an edge of each panel, a second longeron pivotably attached to an opposite edge of each panel, and each longeron includes a hinge between adjacent panels configured to automatically unfold and lock in place. A deployable boom comprising adjacent panels hinged together in an end to end configuration; at least a first longeron hingedly attached to at least two panels; said longeron including a self locking hinge between adjacent panels. The deployable boom in which the self locking hinge includes a first set of plies of foldable material secured on opposite ends thereof to the spaced ends of longeron sections bridging the gap therebetween; and a second set of plies of foldable material secured on opposite ends thereof to the spaced ends of the longeron sections bridging the gap therebetween opposite the first set of plies.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional top view of an example of a deployable boom in accordance with the subject invention;

FIG. 2 is a highly schematic three-dimensional side view of an example of two hinged panels for deployable boom in accordance with the subject invention;

FIG. 3 is a schematic three-dimensional front view showing another embodiment of two hinged panels for a deployable boom in accordance with the subject invention;

FIG. 4 is a schematic three-dimensional front exploded view showing an example of a locking hinge construction for the longerons of the deployable boom of the subject invention;

FIG. 5 is a highly schematic three-dimensional front view showing the assembled locking hinge for two longeron sections in accordance with the subject invention;

FIG. 6 is a highly schematic three-dimensional top view showing the deployable boom of FIG. 1 in its collapsed configuration;

FIG. 7 is a schematic three-dimensional side view showing in detail a portion of the hinged panel construction of the deployable boom shown in FIG. 1;

FIG. 8 is a schematic three-dimensional view showing an example of a means for regulating the rate of deployment of the deployable boom shown in FIG. 1; and

FIG. 9 is a schematic three-dimensional view showing an example of another deployable boom in accordance with the subject invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

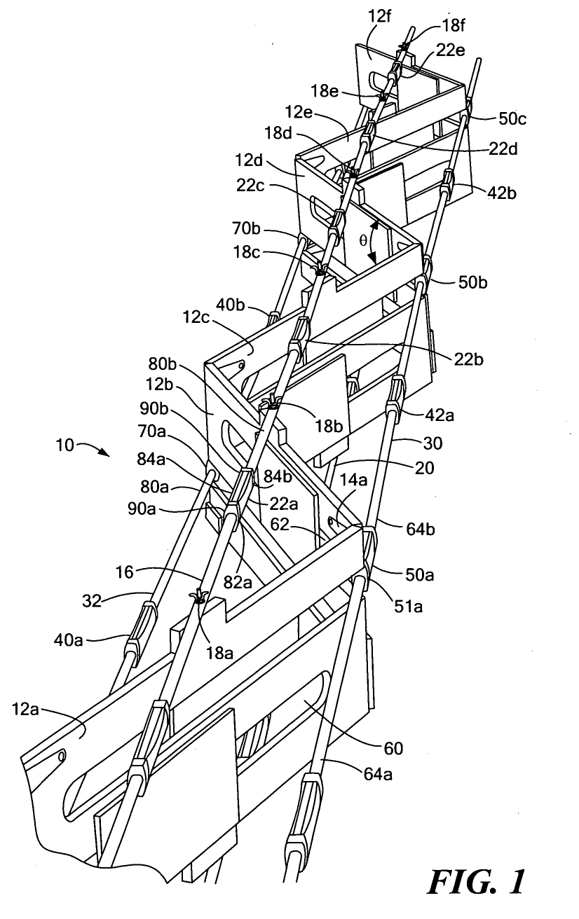

FIG. 1 shows an example of a boom 10 in accordance with the subject invention in its deployed state or configuration. Adjacent panels 12a and 12b are hinged together via hinges as shown for hinge 14a. Typically two spaced hinges pivotably connect adjacent panels. Thus, panel 12a is hinged to panel 12b which is hinged to panel 12c which is hinged to panel 12d which is hinged to panel 12e which is hinged to panel 12f. The number, size, and configuration of the panels can vary. The preferred angle θ between adjacent panels in the deployed configuration ranges from 45° to 75°. In the collapsed configuration, θ is zero or nearly zero.

Longeron 16 is attached to at least two panels, typically every panel, and is preferably pivotably connected via fasteners 18a-18f to an edge of each panel. Longeron 20 is similarly pivotably connected via fasteners to an opposite edge of each panel.

Each longeron 16 and 20 includes, as shown for longeron 16, self locking hinges 22a-22e, at least one each between adjacent panels between pivoting connectors 18a and 18b, between pivoting connectors 18b and 18c, and so on. These hinges allow longeron sections on either side of the hinge to pivot with respect to each other in the same direction as the pivoting of adjacent panels for folding the boom. The hinges then lock in place as shown in FIG. 1 when the boom is deployed. The hinges also serve as the mechanism for deploying the boom once released from its folded, stored configuration. The hinges store energy when folded and automatically return to the configuration shown in FIG. 1 when released.

FIG. 1 also shows optional stiffening longerons 30 and 32. Longeron 32 spans one side of the hinged joints between adjacent panels and longeron 30 spans an opposite side of the hinged joints between adjacent panels. Each of these longerons also typically includes a self locking hinge between adjacent panels. So, longeron 32 includes self locking hinge 40a between adjacent panels 12a and 12b and self locking hinge 40b between adjacent panels 12c and 12d. Similarly, longeron 30 includes self locking hinge 42a between adjacent panels 12b and 12c and self locking hinge 42b between adjacent panels 12d and 12e.

And, longerons 30 and 32 further include self locking hinges proximate the hinged joint between adjacent panels. Thus, longeron 30 includes self locking hinge 50a at the hinged joint between panels 12a and 12b, hinge 50b at the hinged joint between panels 12c and 12d, and hinge 50c proximate the hinged joint between panels 12e and 12f. Each such self locking hinge may be pivotably attached or pinned to the end of a panel. Thus, hinge 50a is pinned by pin 51 a to the end of panel 12a. In this way, hinge 50a is pivotably attached to the end of panel 12a at the hinge joint between panels 12a and 12b.

Cut outs in the panels such as cut out 60 in panel 12a and cut out 62 in panel 12b accommodate pivoting of longeron 30 sections 64a and 64b when the boom is folded. In a similar fashion, longeron 32 also includes self locking hinges 70a, 70b, and the like, one proximate or at each hinge joint between panels longeron 32 spans. These self locking hinges are also pivotably attached to an end of panels 12b and 12d, respectively.

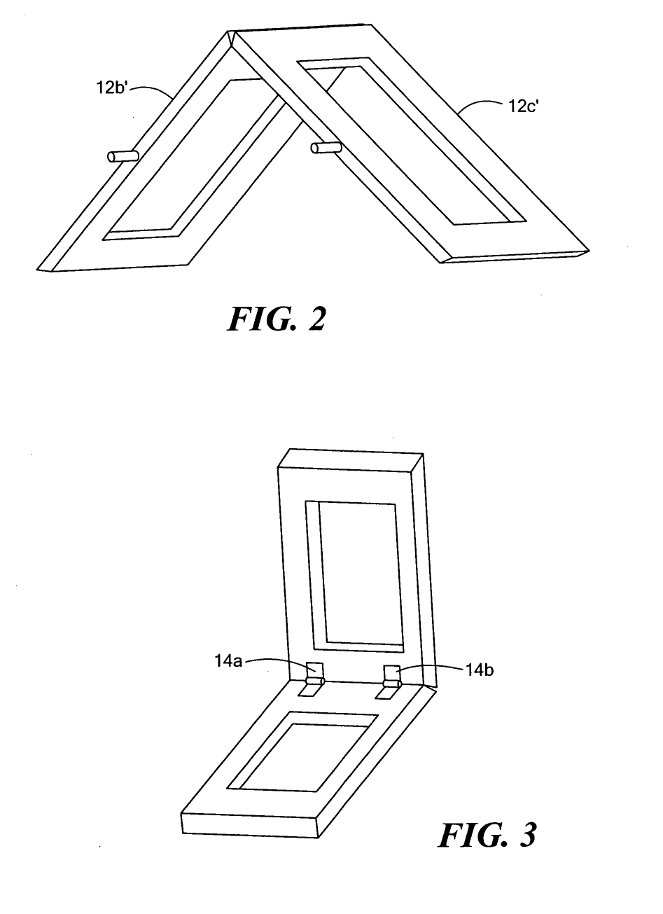

FIG. 2 shows adjacent hinge panels 12b′ and 12c′ in a frame configuration. FIG. 3 shows two panels and the hinges 14a and 14b securing them in an end to end pivoting configuration. The panels could be solid, however, and in any case can be made of a wide variety of materials (composites, for example). The longerons are also typically made of composite materials such as carbon or glass fiber reinforced plastic.

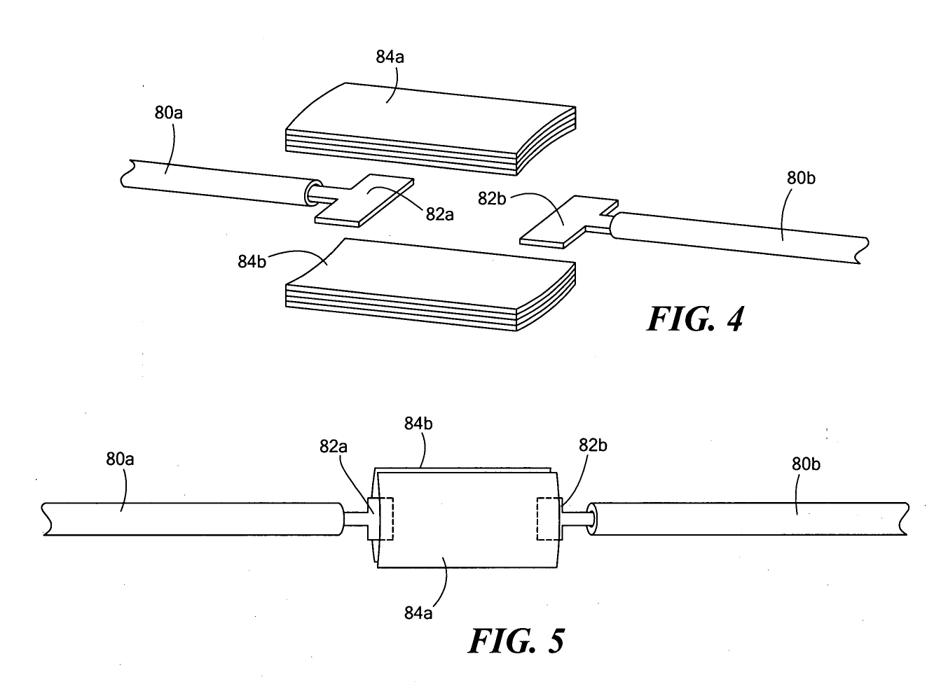

FIGS. 4-5 depict one preferred configuration for the self locking hinges between adjacent longeron sections, e.g., longeron sections 80a and 80b. The end of each longeron section is fitted with a tab, tab 82a for longeron section 80a and tab 82b for longeron section 80b. The tabs are spaced from each other and define a gap. A first set of curved plies of foldable material 84 (e.g., 3-8 plies of composite sheets) such as carbon or glass fiber reinforced plastic are secured on opposite ends thereof to the upper surface (in FIG. 4) of tabs 82a and 82b using, for example, tape. A second set of curved plies 84b are secured on opposite ends thereof to the lower surface (in FIG. 4) of tabs 82a and 82b as shown in FIG. 5.

In FIG. 1, for self locking hinge 22a of longeron 16, plies 84a and 84b can be seen bridging the gap between longeron 16 sections 80a and 80b. Tab 82a is also seen extending from longeron section 80a. Tape is shown at 90a and 90b securing the plies to their respective tabs. Typically, all the self locking hinges of all the longerons are constructed in the same or a similar manner. This construction results in opposing elongated slots separated by longitudinally running strips of material, i.e., the material of ply sets which fold when subjected to localized buckling forces and which unfold, typically, automatically, when released. See co-pending application Ser. No. 10/188,721 filed on Jul. 2, 2002 incorporated herein by this reference. Other self locking hinges, however, are within the scope of this invention.

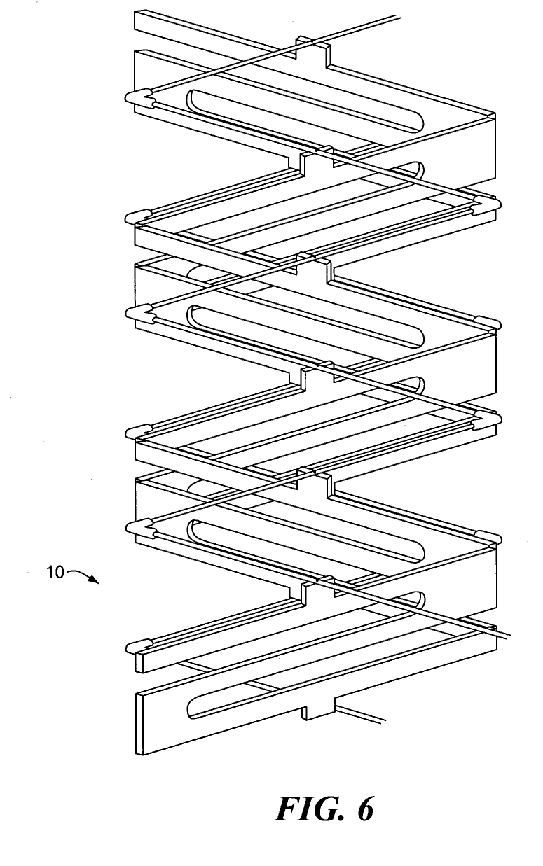

FIG. 6 shows how, when a localize buckling forces is applied to all the locking hinges in the longerons, boom 10 can be folded to a compact configuration for deployment into space whereupon, when it is released, it self deploys and locks into place via the action of the self locking hinges.

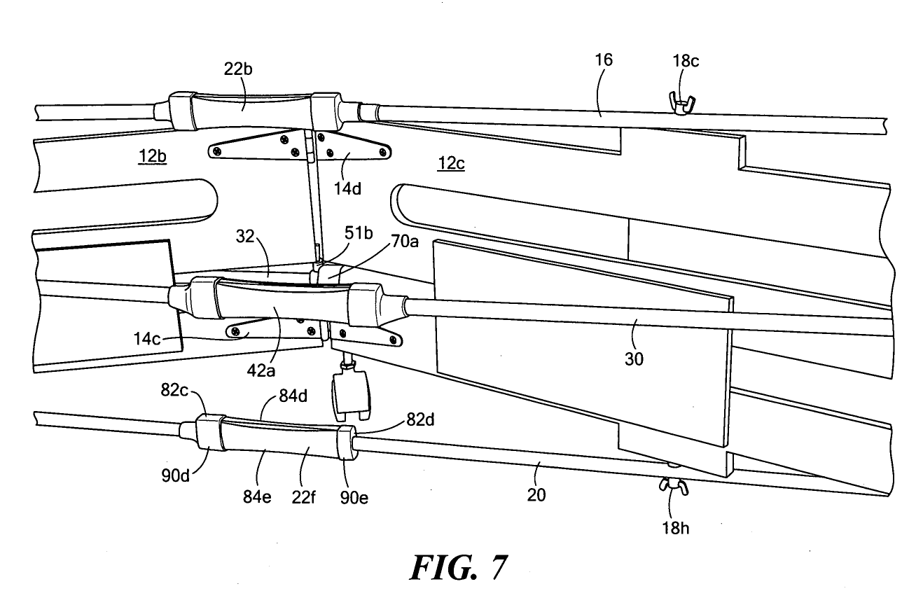

FIG. 7 shows in closer detail two panels 12b and 12c hinged together via hinges 14c and 14d. Longeron 16 is pivotably attached to one edge of panel 12c via fastener 18c and includes self locking hinge 22b between panels 12b and 12c. Longeron 20 is similarly pivotably attached to the opposite edge of panel 12c via fastener 18h and includes self locking hinge 22f between panels 12b and 12c.

Optional stiffening longeron 30 includes self locking hinge 42a between panels 12b and 12c and optional stiffening longeron 32 includes self locking hinge 70a proximate or at the joint between adjacent panels 12b and 12c and pinned to the end of panel 12b via pin 51b.

FIG. 7 also shows, for self locking hinge 22f, tabs 82c and 82d, ply sets 84d and 84e, and tape 90d and 90e securing the two sets of plies on their ends to their respective tabs. The result is a slot between each ply set which allows the plies to bend when subject to a localized buckling force. But, the hinges all unfold by virtue of their stored energy and then lock in place once the adjacent longeron sections become aligned in an end to end configuration. The design of the self locking hinges between adjacent longeron sections may vary but preferably there is a gap between each longeron section where a self locking hinge is desired. The plies of foldable material bridge the gap thus allowing the two longeron sections to fold with respect to each other but automatically unfold into an end to end configuration and in linear alignment with each other whereupon the foldable ply material locks the two longeron section in an end to end linearly aligned configuration as shown in FIG. 1 for longerons 16, 20, 30, and 32.

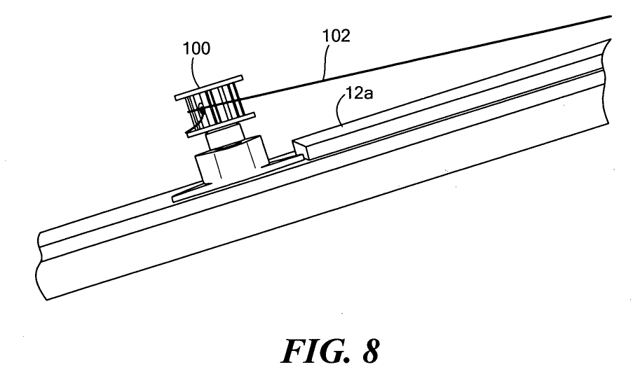

The boom may further include means for regulating the rate of its deployment and the deployment of the panels as they expand from the compact folded configuration shown in FIG. 6 to the deployed configuration shown in FIG. 1. In one example, damping spool 100, FIG. 8 is attached to panel 12a and lanyard 102 is wound thereon. An opposite end of lanyard 102 is attached to a distant panel, e.g., panel 12f in FIG. 1. The lanyard passes through holes in all the intermediate panels. Spool 100 slowly pays out the lanyard 102 to regulate the rate of deployment of the panels as the hinges in the longerons unfold and then lock into place. The friction provided by damping spool 100 can be adjusted depending on the specific design of the boom structure and the deployment rate desired.

The result is a deployable boom which automatically deploys and then locks into place once deployed. It can be collapsed to a fairly small volume and yet, when deployed, the self locking hinges provide substantial bending stiffness orthogonal to the direction of deployment. Motors and/or other actuators are not typically required to deploy the boom but can be added if required.

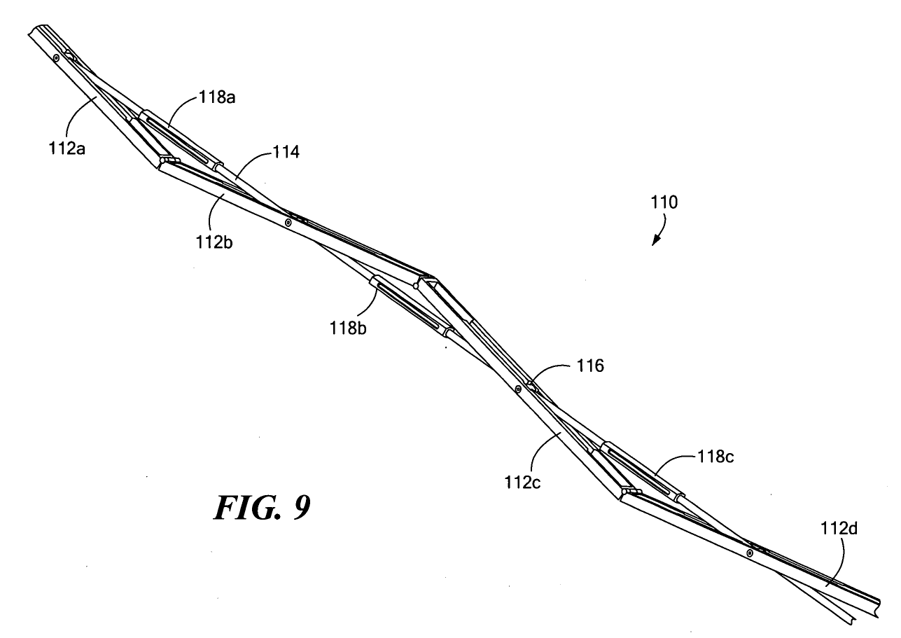

In another embodiment, deployable boom 110, FIG. 9 includes panels 112a-112d hinged together in an end to end configuration as shown and a single longeron 114 hingedly attached to the mid point of each panel via a pin spanning the width of each panel as shown for pin 116. Longeron 114 passes through pin 116 as shown. Longeron 114 includes self locking hinge 118a between panels 112a and 112b, self locking hinge 118b between panels 112b and 112c, and self locking hinge 118c between panels 112c and 112d. FIGS. 4-5 depict the preferred construction of each self locking hinge 118a-108c.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A deployable boom comprising:
adjacent panels hinged together in an end to end configuration;
a first longeron attached to at least two panels;
a second longeron attached to at least two panels;
each longeron including a self locking hinge between adjacent panels.

2. The deployable boom of claim 1 in which the first longeron is pivotably connected to one edge of each panel and the second longeron is pivotably connected to an opposite edge of each panel.

3. The deployable boom of claim 1 in which the self locking hinge includes foldable plies of material.

4. The deployable boom of claim 1 in which the self locking hinge includes:
a first set of plies of foldable material secured on opposite ends thereof to the spaced ends of longeron sections bridging the gap therebetween; and
a second set of plies of foldable material secured on opposite ends thereof to the spaced ends of the longeron sections bridging the gap therebetween opposite the first set of plies.

5. The deployable boom of claim 1 further including a third longeron spanning one side of the hinged joints between adjacent panels.

6. The deployable boom of claim 5 further including a fourth longeron spanning an opposite side of the hinged joints between adjacent panels.

7. The deployable boom of claim 6 in which each of the third and fourth longerons include self locking hinges between adjacent panels.

8. The deployable boom of claim 7 in which each of the third and fourth longerons further include a hinge pivotably attached proximate a hinged joint between adjacent panels.

9. The deployable boom of claim 1 in which the panels are solid.

10. The deployable boom of claim 1 in which the panels are frames.

11. The deployable boom of claim 6 in which the panels include cut outs for accommodating the third and fourth longerons when the boom is folded.

12. The deployable boom of claim 1 in which the longerons are made of composite material.

13. The deployable boom of claim 1 further including means for regulating the rate of deployment of the panels.

14. The deployable boom of claim 13 in which said means include a lanyard wound about a damping reel and secured to at least one panel.

15. A deployable boom comprising:
adjacent panels hinged together;
a first longeron attached to an edge of at least two panels including a self locking hinge between the two panels;
a second longeron attached to an edge of at least two panels including a self locking hinge between the two panels;
a third longeron spanning one side of the hinged joints between adjacent panels; and
a fourth longeron spanning an opposite side of the hinged joint between adjacent panels.

16. A deployable boom comprising:
adjacent panels hinged together;
a first longeron pivotably connected to one edge of each panel;
a second longeron pivotably connected to an opposite edge of each panel; and
each longeron including a self locking hinge between adjacent panels.

17. A deployable boom comprising:
adjacent panels hinged together;
a first longeron attached to at least two panels;
a second longeron attached to at least two panels;
each longeron including a self locking hinge between adjacent panels, the self locking hinge including:
a first set of plies of foldable material secured on opposite ends thereof to spaced ends of adjacent longeron sections bridging the gap therebetween; and
a second set of plies of foldable material secured on opposite ends thereof to spaced ends of the adjacent longeron sections bridging the gap therebetween opposite the first set of plies.

18. A deployable boom comprising:
adjacent panels hinged together in an end to end configuration;
a first longeron pivotably attached to an edge of each panel;
a second longeron pivotably attached to an opposite edge of each panel;
each of the first and second longerons including a self locking hinge between adjacent panels;
a third longeron spanning one side of the hinged joints between adjacent panels;
a fourth longeron spanning an opposite side of the hinged joints between adjacent panels;
the third and fourth longerons include self locking hinges between adjacent panels;
each of the third and fourth longerons further include a hinge pivotably attached proximate a hinged joint between adjacent panels; and
each self locking hinge including foldable plies of material.

19. A deployable boom comprising:
adjacent panels hinged together in an end to end configuration;
a first longeron pivotably attached to an edge of each panel;
a second longeron pivotably attached to an opposite edge of each panel; and
each longeron including a hinge between adjacent panels configured to automatically unfold and lock in place.

20. A deployable boom comprising:
adjacent panels hinged together in an end to end configuration;
at least a first longeron hingedly attached to at least two panels;
said longeron including a self locking hinge between adjacent panels.

21. The deployable boom of claim 20 in which the self locking hinge includes:
a first set of plies of foldable material secured on opposite ends thereof to the spaced ends of longeron sections bridging the gap therebetween; and
a second set of plies of foldable material secured on opposite ends thereof to the spaced ends of the longeron sections bridging the gap therebetween opposite the first set of plies.
